(19) United States
(12) Patent Application Publication
(10) Pub. No.: US 2008/0209520 A1
(43) Pub. Date: Aug. 28, 2008

(54) Method For Authenticating a User and Device Therefor

(75) Inventors: Alain Leclercq, Monaco (MC); Yves Arnail, Belmont sur Rance (FR); Bernard Delbourg, Montpellier (FR); Pierre Rabischong, Montpellier (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MEDISCS SARL, Castelnau Le Lez (FR)

(21) Appl. No.: 12/065,958

(22) PCT Filed: Sep. 6, 2006
(86) PCT No.: PCT/FR06/50845

§ 371 Date: Mar. 6, 2008

(30) Foreign Application Priority Data
Sep. 7, 2005 (FR) 0552701

(51) Int. Cl. G06F 21/20; H04L 9/32

(52) U.S. Cl. 726/3; 713/182

(57) ABSTRACT

The invention concerns a method for authenticating a user via a terminal (1) connected to a network (2) and comprising means (4) for reading a medium (3), wherein, when said support (3) is created, identifying data (5) concerning said user are recorded on the medium (3) by etching means and on storage means (6); data (7) concerning the etching of said medium (3) are collected and stored in the form of a trace via said storage means (6), said trace indexing random errors occurring during etching; and, wherein, when said medium (3) is used, said identifying data (5) are read and transmitted via secure connection means (8) to said remote storage means (6) via said network (2) for comparing and authenticating same.

### BACKGROUND OF THE INVENTION

(1) Field of the Invention

This invention relates to a method for authenticating a user via a terminal connected to a computer network and comprising means for reading a ROM memory medium, such as a CD, CD CARD or DVD.

This invention falls into the field of secure remote authentication of a user, in particular the identification of a user by means of a computer network.

The invention relates more specifically to such an authentication method and the device for implementing same.

This invention will find its application in particular in the field of banking and on-line payment, like a bank card.

(2) Description of the Prior Art

As is well-known, the remote authentication of a user connected to a computer network by means of a computer can occur by means of a system using a chip card. Like the systems using bank cards, a computer can be provided with a terminal for reading a chip card. The latter contains authentication information, such as for example an electronic signature, which is then transferred from said terminal via said network in order to be compared, subsequently authenticated. Access is then allowed. In addition, as is well-known, the connection is secured by means of well-known tools and encryption protocols.

However, such a device does not offer sufficient security, particularly in case of theft of the card that can then be used on another terminal. This is why the bank devices use a code known only by the user. In addition, this type of device requires the purchase and installation of a specific reader designed for reading the card. Said reader, generally external, is just means for reading the data contained on the chip card and has no encryption means. Therefore, it does not offer any security for the transmission between the terminal and the computer, in particular via its physical wired link.

Moreover, in a secure access to a site for on-line payment by bank card, for example on the Internet, no code is required. It is enough to enter the numbers written on the card in order to validate the purchase. Again, in case of theft of the latter, there is no security to prevent fraudulent use.

For these reasons, through WO 01/59547 was devised a medium that is compatible with most of the readers existing on a terminal, in particular ROM memory readers, such as a CD or DVD player. A PIN code is required on each insertion of said CD/DVD in order to authenticate the user.

However, the utilization of a medium as widespread as the CD or the DVD does not prevent the reproduction of the latter.

Therefore, it was thought to prevent this reproduction by means of voluntary generation, during the writing of said medium, of marks. The latter are then counted by an appropriate software and contribute to the identification of said medium. This solution is briefly described in WO 2004/084487.

The disadvantage of this solution resides in that, considering that it is possible to knowingly generate marks during the writing process, an appropriate software will be able to read said marks and thus reproduce them during a copying operation for the purpose of falsifying the medium.

In addition, the entering of bank details, even by means of a secure connection, can be pirated by the presence of spyware. Moreover, said data can be stored on the site, even temporarily, and represent a security flaw.

Finally, if the data on the card are copied, there is nothing to prevent the falsification of this card and its reproduction.

### SUMMARY OF THE INVENTION

The object of the invention is to cope with the disadvantages of the state of the art by providing a secure authentication method and a device for implementing same offering optimum security, an impossible reproduction making them unfalsifiable.

In particular, the invention creates a link between the data contained on a medium and the medium itself, so that it is impossible to copy the one independently from the other. In particular, in the case of this invention, the data related to the medium refer to the errors occurring during the writing of said medium.

Similar methods exist in prior art.

Through this strong authentication of the medium, the procedure avoids entering the bank details by the user. Furthermore, the procedure regarding the transmission of said bank details is then transparent for said user.

In addition, the medium is designed to be compatible with the readers equipping most computer terminals, such as DVD or CD players.

Therefore, this invention provides a unique solution for a secure and unfalsifiable payment.

To this end, this invention relates to a method for authenticating a user via a terminal connected to a computer network and comprising means for reading a ROM memory medium, such as a CD, CD CARD or DVD, wherein, during the creation of said medium:
identification data regarding said user are recorded, on the one hand, on said medium through writing means and, on the other hand, on storage means;
information related to the writing of said medium is collected and stored in the form of a trace by means of said storage means, said trace indexing random errors occurring during the writing of said medium; and wherein, during the utilization of said medium
said identification data are read by said reading means and transmitted via secure connection means to said remote storage means via said network;
said transmitted data are compared with said data contained on said storage means in order to be authenticated; said method consisting also in
physically controlling said medium during its reading and transmitting the results of said control to said remote storage means;
comparing the result of its control with said trace in order to authenticate said medium; and, after authentication of said medium and of said information, permitting said user's access to an application.

According to other features of the invention, connection via secure means consists in
during the creation of said medium, recording a code on said storage means
during the utilization of said medium, executing means for entering said code by a user; then encrypting said code and transmitting it by means of a secure connection from said network to said storage means; and controlling the validity of said code by comparison with the code contained in said storage means.

In addition, such a method can consist in transmitting, transparently for the user, bank data in order to automatically fill out an on-line payment form.

The invention also relates to a device for implementing the authentication method, comprising a medium containing personal data related to a user and capable of being read via a terminal provided with reading means, said terminal being connected, by means of a computer network, to means for comparing, on the one hand, said personal data with data contained on storage means and, on the other hand, information related to the writing of said data on said medium with collected information related to the physical level of said medium in the form of a trace indexing random errors occurring during the writing of said medium.

Advantageously, said comparing means include means for writing data related to the user on said medium and means for collecting information related to said writing, and means for storing said data and said information.

According to an embodiment, said medium is a ROM memory comprising a chip.

Other features and advantages of the invention will become clear from the following detailed description of the non-restrictive embodiments of the invention, with reference to the attached FIGURE, which is a schematic representation of how the invention works.

### DETAILED DESCRIPTION OF THE PREFERRED EMBODIMENTS

This invention relates to a method for authenticating a user and a device for implementing same. In particular, the invention is meant for authenticating a user from a terminal 1 connected to a computer network 2.

In this connection, the network 2 is preferably the Internet network, but the invention also relates to any computer network in which two terminals are connected to each other.

The invention will find its application in the secure connection of a user, during the transmission of information requiring a high level of confidentiality, for example in case of accessing an on-line payment site where it is necessary to communicate risk bank data. The invention is also meant for any type of connection or access in which it is necessary to identify in a secure way the user wishing to connect, for example in case of an intranet network or similar.

Advantageously, in order to allow the abovementioned access, this invention ensures a strong authentication of the user's personal medium and therefore of the user himself/herself. It uses the combined comparison, on the one hand, of characteristics related to a physical medium 3 with information related to the same characteristics stored beforehand and, on the other hand, of information stored or contained on said medium with information stored beforehand.

To this end, a user wishing to connect to an application, a payment site or similar, is provided with a terminal 1, connected to said computer network 2, and comprising means 4 for reading said medium 3.

In this connection, the medium 3 is a medium equipped with a ROM memory such as a CD, CD CARD or DVD. Said memory can be rewritable, as a CD or a DVD-RW, or non rewritable, this feature conferring then and there to said medium 3 a security preventing the modification of data recorded thereon. It should be noted therefore that the reading means 4 are of a well-known type, such as a ROM memory reader, as a CD and DVD player.

According to a particular embodiment, said medium 3 can include a chip so that it is compatible with the chip card systems, in particular in case of a medium of the CD CARD type.

The medium 3 has been made beforehand and sent by means of a classical delivery network, for example by post. During the creation of said medium 3, identification data 5 are recorded on said medium 3. Said data are personal for each user and can be related to the identity of the person (first, middle, and last name, details, bank account number, etc.) and can contain a connection identifier for the recognition of said medium 3 during the utilization of the latter. Said data can also include user's bank details, said medium 3 being able to be released by a bank institution. The recording of said data is made by writing by means of classical writing means. On the other hand, the same data are copied and stored in storage means 6.

An advantage of this invention resides in that information 7 related to the writing of said medium 3 are stored on said storage means 6. This writing information 7 is collected in the form of a trace after the finalization of said medium 3. Said trace indexes the errors occurring during this writing operation at the physical level of said medium 3. As a matter of fact, each writing produces random physical errors, impossible to reproduce, and unique for each medium 3. Just like a fingerprint, the surface of said medium 3 contains therefore identification specific to it. An advantage in terms of security therefore consists in comparing the trace of the medium 3 with the medium 3 used during the connection. Thus, any reproduction or duplication of the medium 3 would be impossible.

Another advantage resides in that only the trace of the inserted medium 3 is transmitted on the network, the comparison being made with the trace stored on a remote server. Thus, in case of falsification, the original data are not transmitted, minimizing piracy risks.

In addition, during the utilization of said medium 3, the user inserts said medium 3 in the reading means 4. Said identification data 5 contained on said medium 3 are then read and transmitted by means of secure connection means 8 to said storage means 6. This transfer is made via said network 2, the terminal 1 and the storage means 6 being remote.

It should be noted that said data can be encrypted and/or encoded beforehand in order to prevent any modifications or interception during transfer. In addition, secure connections and secure data transfer protocols can be used (SSL, encryption by private and public keys or other).

Then there is a step of verification of the identification data 5 transmitted. In particular, the communicated identifier permits to find in the storage means 6 the data recorded beforehand thereon and related to the user and to his/her bank details. The cohesion of the data 5 permits a first step in the authentication of the user.

It should be noted that this data-authentication procedure is made transparently for the user. Then it is not necessary for him/her to enter his/her bank details, minimizing the piracy risks, in particular through a spyware residing on user's terminal.

In addition, the bank details can be specific to on-line use, by means of specific forms filled out automatically by means designed for this purpose. The invention consists in transmitting, transparently for the user, bank data in order to automatically fill out an on-line payment form.

During the reading of said medium 3, the latter is physically verified in order to list the apparent writing errors. The same procedure is used with similar means, in particular an application conceived and designed for this purpose, to list said errors as well as to index the writing information 7 mentioned above. The result of this verification is transmitted, securely or not, to said remote storage means. This result is then compared with the trace there, thus authenticating strongly the medium 3. This comparison is made through comparing means 11.

These two authenticating steps then guarantee a perfect and unique identity between the data recorded initially on the medium 3 and the medium used by the user to connect.

The comparison of the identification data 5 and of the information 7 related to the writing is made by comparing means 11 connected to said network 2 and to said storage means 6. In this connection, the latter can group together the data stored thereon in a common way in the form of a database.

Advantageously, to make protection even stronger, the connection via secure means 8 can be based on entering and encrypted sending of a confidential code 9, known only by the user. This code can be transmitted to the user together with said medium 3 or separately, by classical postal delivery means, by electronic mail or by any other means. During the reading of said medium 3, an application is executed on said terminal 1 which opens entering means 10 by means of which the user can type his/her code 9. Said entering means 10 include an interface permitting to enter said code 9, in particular by means of a keyboard or a numeric keypad, in particular a secure numeric keypad.

According to a first embodiment, the code 9 can be compared directly with a code that is encoded and encrypted on the medium 3. In this way, the medium 3 can be recognized during each introduction in the reader 4 and can no longer be required subsequently. This utilization option facilitates repeated identifications of one and the same user, for example in case of several distinct consecutive purchases.

According to another embodiment, the code 9 is then encrypted and sent via network 2, passing through secure lines, to said storage means 6. It is then decrypted and compared with the code recorded beforehand, during the creation of the medium 3, on said storage means 6. Once the validity of the code 9 has been verified, the user, through the authentication of the medium 3 as mentioned above, obtains access authorization.

In order to limit fraud possibilities, the user can enter said code 9 up to three times before the blocking of said data 5 contained in said storage means 6. In other words, access to the data is immediately blocked and subsequent utilization of the medium 3 will not permit any connection. In addition, security messages can be sent to an administrator managing the system. The medium 3 is then unusable until the restoration of access to the data or the creation of another medium 3.

Another particularity resides in that it is not necessary to memorize a user name. Similarly to bank card systems, it is enough to enter the code 9. In addition, the entering of a code 9 greatly improves security, in particular in case of theft of the medium 3.

The preceding comparison steps are carried out through comparing means 11, which are remote and connected, on the one hand, to the storage means 6 and, on the other hand, to said network 2. On request, they permit to compare data received by the network with data contained in the storage means 6, in particular, and also transmitted data with the identification data 5, data related to the medium 3 with the trace, and finally the code 9.

Therefore, this invention provides secure means for accessing sensitive zones on a network, in an absolutely secure way. A preferred dedicated application remains payment on the Internet. It is therefore no longer necessary to transmit one's bank details from one's terminal or one's computer the security of which is weaker than that of bank networks.

In addition, the invention does not require any additional device and is adaptable to any terminal equipped with a reader of the type CD, DVD or similar. Compatibility is therefore optimal, yet providing a strong authentication of the medium 3 and of its user.

1. Method for authenticating a user via a terminal connected to a computer network and comprising means for reading a ROM memory medium, such as a CD, CD GARD or DVD, wherein, during the creation of said medium:
identification data related to said user are recorded, on the one hand, on said medium by writing means and, on the other hand, on storage means;
information related to the writing of said medium is collected and stored in the form of a trace by said storage means, said trace indexing random errors occurring during the writing of said medium; and wherein, during the utilization of said medium:
said identification data are read by said reading means and transmitted through secure connection means to said remote storage means via said network;
said transmitted data are compared with said data contained on said storage means in order to be authenticated; said method also consists in:
physically verifying said medium during its reading and transmitting the results of said verification to said remote storage means;
comparing the result of its verification with said trace, in order to authenticate said medium; and, after authentication of said medium and of said information, authorizing said user's access to an application.

2. Method for authenticating according to claim 1, wherein the connection via secure means consists in:
during the creation of said medium, recording a code on said storage means;
during the utilization of said medium, executing means for entering by a user of said code; then encrypting said code and transmitting it by means of a secure connection from said network to said storage means; and verifying the validity of said code by comparison with the code contained in said storage means.

3. Method for authenticating according to claim 1, wherein it consists in transmitting, transparently for the user, bank data in order to automatically fill out an on-line payment form.

4. Device for implementing the authentication method according to claim 1, wherein it includes a medium containing personal data related to a user and capable of being read via a terminal provided with reading means, said terminal being connected, through a computer network, to means for comparing, on the one hand, said personal data with data contained on storage means and, on the other hand, information related to the writing of said data on said medium with collected information related to the physical level of said medium in the form of a trace indexing random errors occurring during the writing of said medium.

5. Device according to claim 4, wherein said comparing means include means for writing the data related to the user on said medium and means for collecting information related to said writing, and means for storing said data and said information.

6. Device according to claim 5, wherein said medium has a ROM memory comprising a chip.

7. Method for authenticating according to claim 2, wherein it consists in transmitting, transparently for the user, bank data in order to automatically fill out an on-line payment form.
